(19) United States
(12) Patent Application Publication
(10) Pub. No.: US 2024/0067873 A1
(43) Pub. Date: Feb. 29, 2024

(54) BRIGHTLY COLOURED CERAMIC ARTICLE AND ITS METHOD OF MANUFACTURE

(71) Applicant: THE SWATCH GROUP RESEARCH AND DEVELOPMENT LTD, MARIN (CH)

(72) Inventors: Marta FORNABAIO, Crissier (CH); Lucie TABARD, Neuchâtel (CH); Stewes BOURBAN, Chabrey (CH)

(73) Assignee: THE SWATCH GROUP RESEARCH AND DEVELOPMENT LTD, MARIN (CH)

(21) Appl. No.: 18/306,597

(22) Filed: Apr. 25, 2023

(30) Foreign Application Priority Data
Aug. 23, 2022 (EP) 22191781.8

(51) Int. Cl. C09K 11/04; C04B 35/10; C04B 35/48; C04B 35/505; C04B 35/626; C04B 35/632; C04B 35/645; C09K 11/77

(52) U.S. Cl. CPC C09K 11/04; C04B 35/10; C04B 35/48; C04B 35/505; C04B 35/62695; C04B 35/632; C04B 35/6455; C09K 11/7774; C04B 2235/3222; C04B 2235/3244; C04B 2235/656; C04B 2235/764; C04B 2235/9661

(57) ABSTRACT

A coloured article made of a ceramic including an oxide-based matrix and a doped or co-doped component of the aluminium garnet family, and a method for manufacturing the article.

### CROSS REFERENCE TO RELATED APPLICATIONS

This application claims priority to European Patent Application No. 22191781.8, filed on Aug. 23, 2022, the entire contents of which are incorporated herein by reference.

### TECHNICAL FIELD OF THE INVENTION

The present invention relates to a brightly coloured ceramic article and in particular to a horological casing or movement component made from an oxide-based material such as alumina. It also relates to the method for manufacturing said article.

### TECHNOLOGICAL BACKGROUND

Coloured ceramics are commonly produced industrially by mixing a metal oxide-based matrix, for example Al₂O₃, ZrO₂ and composites thereof, with a colouring pigment. In some cases, the ceramic may be coloured by doping with different atoms entering the crystalline structure. The colours obtained in this way are generally pale. For example, yellow colouring of the ceramic is often achieved by doping with praseodymium or by adding pigment based on tungsten oxide and/or vanadium oxide. The coloured obtained is usually pale yellow or turning to orange.

An alternative has been proposed in the field of horology by document WO 2018/172428 which discloses the manufacture of a brightly coloured ceramic part by incorporating a pigment encapsulated in a metal oxide matrix adapted to allow light to pass through. More precisely, the method envisages the use of unconventional sintering under pressure in order to densify the material, a method which is complex to implement industrially.

### SUMMARY OF THE INVENTION

The object of the present invention is to provide a new brightly coloured ceramic composition which allows an article to be produced using an expensive method.

More precisely, the present invention relates to a coloured article made of ceramic comprising an oxide-based matrix and a doped or co-doped component of the aluminium garnet family.

In more detail, the doped or co-doped component of the aluminium garnet family, such as cerium-doped yttrium aluminium garnet (YAG:Ce) gives the oxide-based ceramic a bright and brilliant colour. Such a colouring element not only represents an alternative to conventional colouring pigments, but also makes it possible to obtain a more intense shade and to significantly extend the range of possible colours. Furthermore, the development of a composite by adding an oxide-based matrix allows the use of pure YAG to be dispensed with, which means a significant reduction in costs and a significant improvement in toughness and machinability.

When the component of the aluminium garnet family is doped with chromium or with an element of the lanthanide family, such as for example cerium, neodymium, erbium, holmium and ytterbium, an intense and vivid colour is obtained. In particular, when it is doped with cerium, a yellow colour is obtained. This bright colour cannot be obtained by mixing with commercial pigments or by doping with different atoms. When it is doped with neodymium, a violet colour is obtained and when it is doped with chromium a colour ranging from green to red is obtained, depending on its oxidation state. When it is doped with erbium, a pink colour is obtained. When it is doped with ytterbium, a green colour is obtained. Co-doping with one or more additional elements selected from chromium and an element of the lanthanide family, such as cerium, erbium, ytterbium, holmium and neodymium, makes it possible to modulate these colours and thus broaden the range of the colours that can be obtained. The use of a doped or co-doped component of the aluminium garnet family thus makes it possible to obtain bright and brilliant colours with re-emissive properties.

The article obtained in this way with these different dopants has a bright colour with an L component in the Lab color space greater than or equal to 80, preferably greater than or equal to 85, more preferably greater than or equal to 90.

It has a hardness that is greater than or equal to 1000 HV10, preferably greater than or equal to 1200 HV10, more preferably greater than or equal to 1550 HV10.

It has a toughness K_{iC} of between 1.7 and 6 MPa √m, typically between 2 and 4.5 MPa √m.

The present invention also relates to the method for manufacturing said article including the following steps:
producing a base mixture, also referred to as the first mixture, with the oxides and the doped or co-doped component of the aluminium garnet family, and this optionally in a liquid medium,
forming a second mixture comprising the first mixture and an organic binder system,
granulating said second mixture,
forming a blank having the shape of the article,
sintering the blank in air at a holding temperature of between 1500 and 1800° C., preferably between 1600 and 1700° C., for a period of between 20 minutes and 20 hours, preferably between 1 hour and 5 hours.

The proposed method, by mixing powders and conventional sintering, can be easily industrialised and has a lower economic impact than current methods that involve manufacture by SPS (Spark Plasma Sintering) or with a composition comprising pure YAG.

Other features and advantages of the invention will become more apparent on reading the following detailed description, with reference to the appended drawings.

### BRIEF DESCRIPTION OF THE FIGURE

FIG. 1 represents a timepiece comprising a middle made of the ceramic material according to the invention.

### DETAILED DESCRIPTION OF THE INVENTION

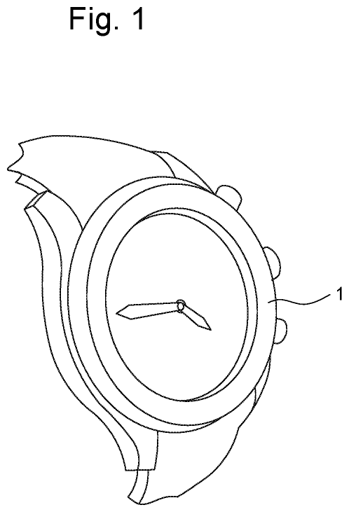

The present invention relates to an article made from an oxide-based ceramic material. The article may be a decorative article such as a constituent element of watches, jewellery, wristlets, etc. or more generally an outer portion of a portable element such as a shell of a mobile phone. In the watchmaking field, this article may be an external part such as a middle, a bottom, a bezel, a crown, a bridge, a push-piece, a wristlet link, a dial, a hand, a dial index, etc. For illustration, a middle made with the ceramic material according to the invention is represented in FIG. 1. It may also consist of a component of the movement such as a plate or an oscillating mass.

The ceramic material includes the oxide-based matrix. The oxides can be ZrO₂, Al₂O₃, TiO₂, SiO₂, MgAl₂O₄ and ZnO or a mixture of these oxides such as Al₂O₃+ZrO₂. In the presence of zirconia (ZrO₂), the latter is generally stabilised by yttrium, cerium, calcium or magnesium. Preferably, the matrix is based on Al₂O₃. The ceramic material further comprises a doped or co-doped phosphorescent dye component of the aluminium garnet family. The percentage by weight of the doped or co-doped component of the aluminium garnet family is between 5 and 85%, preferably between 5 and 70%, more preferably between 10 and 60%, relative to the total weight of the ceramic material. Thus, the ceramic material comprises by weight between 15 and 95%, preferably between 30 and 95%, more preferably between 40 and 90%, oxides and between 5 and 85%, preferably between 5 and 70%, more preferably between 10 and 60%, of the doped or co-doped component of the aluminium garnet family.

The aluminium garnets may be yttrium aluminium garnet (YAG) or lutetium aluminium garnet (LuAG). It is preferably yttrium aluminium garnet. These garnets are doped or co-doped respectively with one or more elements of the lanthanide family: cerium, neodymium, holmium, erbium and ytterbium, or with chromium. Preferably, the garnet is doped with cerium. More preferably, it is yttrium aluminium garnet doped with cerium. Even more preferably, the article includes an alumina-based matrix (Al₂O₃) and yttrium aluminium garnet doped with cerium (YAG:Ce). This ceramic may also include possible impurities with a content less than or equal to 0.2% by weight, or 0.1% by weight.

Advantageously, the ceramic consists of the oxide-based matrix, the doped or co-doped component of the garnet family and possible impurities. Preferably, the ceramic consists of the alumina-based matrix (Al₂O₃) and yttrium aluminium garnet doped with cerium (YAG:Ce) and possible impurities.

According to the invention, the component of the garnet family is doped with one of the aforementioned elements and possibly co-doped with one or more of the aforementioned elements with a total atomic percentage for the dopant and the possible co-dopant or co-dopants relative to this component being between 0.1 and 50%. The doping is with cerium when a yellow colour is desired. Preferably, for doping with cerium, the atomic percentage relative to the component of the garnet family is between 0.5 and 10%, more preferably between 1 and 5%. The doping is with chromium when a colour ranging from green to red is desired, depending on the degree of oxidation of the chromium. For chromium doping, the atomic percentage relative to the component of the garnet family is between 0.1 and 50%. The doping is with neodymium when a violet colour is desired. Preferably, the atomic percentage relative to the component is between 0.9 and 11%. The doping is with erbium when a pink colouration is desired with an atomic percentage relative to the component being between 0.1 and 50%. The doping is with ytterbium when a green colouration is desired with an atomic percentage relative to the component of between 0.1 and 50%. The addition of a co-dopant makes it possible to change the colour. For example, it could be a component of the garnet family doped with cerium and co-doped with neodymium.

The article with one or more dopants has a bright colour with an L component in the Lab colour space greater than or equal to 80, preferably greater than or equal to 85, more preferably greater than or equal to 90. It has a hardness that is greater than or equal to 1000 HV10, preferably greater than or equal to 1200 HV10, more preferably greater than or equal to 1550 HV10. For a matrix of aluminium oxides with yttrium aluminium garnet doped with cerium, it has a hardness greater than or equal to 1400 HV10, preferably greater than or equal to 1550 HV10. For a matrix of zirconium oxides with cerium-doped yttrium aluminium garnet it has a hardness greater than or equal to 1250 HV10, preferably greater than or equal to 1400 HV10. Similarly, for a matrix of aluminium oxides and zirconia with cerium-doped yttrium aluminium garnet, it has a hardness greater than or equal to 1250 HV10, preferably 1400 HV10. The article has a toughness K_{iC} of between 1.7 and 6 MPa √m, preferably between 2 and 4.5 MPa √m. For a matrix of aluminium oxides with cerium-doped yttrium aluminium garnet, it has a toughness K_{iC} greater than or equal to 2 MPa √m. For a matrix of aluminium oxides and zirconia with cerium-doped yttrium aluminium garnet, it has a toughness K_{iC} greater than or equal to 2.5 MPa √m. For a matrix of zirconium oxides with cerium-doped yttrium aluminium garnet, it also has a toughness K_{iC} greater than or equal to 2.5 MPa √m. The article has a density greater than or equal to 95%, preferably greater than or equal to 97%, more preferably greater than or equal to 98%.

The ceramic article with the alumina matrix and the cerium-doped yttrium aluminium garnet has a yellow colour with in the CIELAB color space (according to standards CIE no. 15, ISO 7724/1, DIN 5033 part 7, ASTM E-1164) a component L* greater than or equal to 85, preferably greater than or equal to 90, a component a* of between −5 and 15, preferably between −5 and 12 and a component b* between 65 and 110, preferably between 70 and 97.

The ceramic article with the alumina and zirconia matrix and the cerium-doped yttrium aluminium garnet also has a yellow colour with in the CIELAB color space (according to standards CIE no. 15, ISO 7724/1, DIN 5033 part 7, ASTM E-1164) a component L* greater than or equal to 85, preferably greater than or equal to 90, a component a* of between −5 and 5, preferably between −5 and 2 and a component b* of between 45 and 80, preferably between 50 and 70.

The article is manufactured by sintering with the method consisting of:
producing the base mixture, also referred to as the first mixture, with the different components mentioned above and possibly in a liquid medium,
forming a second mixture comprising the first mixture and an organic binder system (paraffin, polyethylene, polyvinyl acetate, etc.),
granulating and, if necessary, drying said second mixture, for example in an atomiser. Preferably, the granulates have a size d50 of between 10 and 100 μm, and, preferably of between 40 and 60 μm,
forming a blank by giving this second granulated mixture the shape of the desired item, for example, by injection or pressing. Preferably, the shaping is performed by uniaxial pressing and/or cold isostatic pressing (CIP),
sintering the blank in air at a holding temperature of between 1500 and 1800° C., preferably between 1600 and 1700° C., for a period of between 20 minutes and 20 hours, preferably between 1 hour and 5 hours. This step makes it possible to achieve a densification of more than 97% compared to the theoretical density. This step can be preceded by a thermal debinding step in a temperature range of between 200 and 1200° C. It could also be solvent debinding in the case of injection moulding,
optionally, pressing the blank with hot isostatic pressing (HIP) at a temperature which is 50° C. to 150° C. lower than the sintering temperature in order to improve the final density of the blank.

The blank obtained in this way is cooled. It can then be machined, polished and decorated if necessary to obtain the desired article. As the colour is present within the mass of the blank, these finishing operations do not alter the final colour of the article.

Tests were carried out on the ceramics comprising alumina and cerium-doped yttrium aluminium garnet with percentages for cerium-doped yttrium aluminium garnet (YAG:3Ce) of between 10 and 60% by weight. Tests were also carried out on the ceramics comprising an alumina and zirconia matrix stabilised with yttrium and cerium-doped yttrium aluminium garnet with a percentage for cerium-doped yttrium aluminium garnet (YAG:3Ce) of 50% by weight. Tests were also carried out on the ceramics comprising a zirconia matrix and cerium-doped yttrium aluminium garnet with a percentage of 20% by weight for the latter. In all of these tests, the doping is 3% atomic relative to the garnet and the zirconia is stabilised. The results are shown below in Table 1. The hardness measurements are HV10 hardnesses. The toughness was determined on the basis of the crack length measurements at the four ends of the diagonals of the hardness imprint according to the formula:

$${K}_{1 C} = 0.0319 \frac{P}{{al}^{1 / 2}}$$

where P is the load applied (N), a is the half-diagonal (m) and l is the measured crack length (m).

The Lab colorimetric values were measured on the polished samples with a CM-3610 A spectrophotometer in the following conditions: measurements SCI (specular reflectance included) and SCE (specular reflectance excluded), inclination of 8°, measurement area MAV of 4 mm diameter.

The samples were sintered in air at a temperature of between 1600° C. and 1700° C. for a period of between 2 and 4 hours. All of the samples obtained had a yellow colour. The colorimetry measurements showed a very high brilliance with L* values above 90 compared to the L* values of about 80 in the case of zirconia coloured by the addition of praseodymium oxide. Also, colorimetry measurements show a very high yellow tint with b* values above 75 for an alumina matrix, compared to b* values of about 30 in the case of zirconia coloured by the addition of praseodymium oxide. This yellow component intensifies with increasing content of cerium-doped yttrium aluminium garnet. On the other hand, the toughness and hardness decrease with this increase in content. As a function of the content of cerium-doped aluminium yttrium garnet, it is thus possible to modulate the properties and colour according to the needs of the application.

For the matrices comprising zirconia, the yellow is a little less intense with values for b* of in the order of 50 but still higher than values of 30 in the case of zirconium coloured by the addition of praseodymium oxide. In terms of hardness, values above 1250 HV10 are obtained. For the toughness, values above 2.5 MPa √m are obtained.

TABLE 1

| | | | | | | Properties | | |
|---|---|---|---|---|---|---|---|---|
| Composition (wt %) | | | Colorimetry | | | Hardness | Toughness | Density |
| YAG:3Ce | Al₂O₃ | ZrO₂ | L* | a* | b* | [HV10] | [MPa√m] | [%] |
| 10 | 90 | / | 94.8 | −3.5 | 76.7 | 1698 | 3.4 | 98.8 |
| 20 | 80 | / | 93.8 | 3.2 | 86.1 | 1680 | 4 | 99 |
| 40 | 60 | / | 95.3 | 6.9 | 92.5 | 1612 | 2.7 | 97.2 |
| 60 | 40 | / | 94.3 | 10.3 | 93.6 | 1600 | 2.3 | 99.5 |
| 20 | / | 80 | ** | ** | ** | 1460 | ** | 98 |
| 50 | 40 | 10 | 91 | −1.2 | 56.95 | >1250 | 2.95 | ** |

** not measured

1. A coloured article made from a ceramic comprising an oxide-based matrix and a doped or co-doped component of the aluminium garnet family.

2. The article according to claim 1, wherein the ceramic comprises the oxide-based matrix with a content by weight of between 15 and 95% and the doped or co-doped component of the aluminium garnet family with a content by weight of between 5 and 85%.

3. The article according to claim 1, wherein the ceramic comprises the oxide-based matrix with a content by weight of between 30 and 95%, and the doped or co-doped component of the aluminium garnet family with a content by weight of between 5 and 70%.

4. The article according to claim 1, wherein the component of the aluminium garnet family is doped or co-doped with one or more elements with a total atomic percentage for all of the element(s) of between 0.1 and 50% relative to the component of the aluminium garnet family.

5. The article according to claim 1, wherein the doped or co-doped aluminium garnet family comprises lutetium aluminium garnet and yttrium aluminium garnet and wherein the doping or co-doping element is selected from chromium or an element of the lanthanide family.

6. The article according to claim 5, wherein the element from the lanthanide family is selected from cerium, neodymium, erbium, holmium and ytterbium.

7. The article according to claim 6, wherein for neodymium doping, the atomic percentage relative to the component of the aluminium garnet family is between 0.5 and 10%.

8. The article according to claim 6, wherein for neodymium doping, the atomic percentage relative to the component of the aluminium garnet family is between 0.9 and 11%.

9. The article according to claim 1, wherein the ceramic comprises a matrix based on aluminium oxides, zirconium oxides or stabilised zirconium oxides or a mixture of these oxides.

10. The article according to claim 6, wherein the ceramic comprises a matrix based on aluminium oxides and a cerium-doped yttrium aluminium garnet possibly with a co-doping element.

11. The article according to claim 1, wherein the ceramic consists of the oxide-based matrix and a doped or co-doped component of the aluminium garnet family and possible impurities.

12. The article according to claim 1, wherein the ceramic has in the CIELAB color space a component L* greater than or equal to 80.

13. The article according to claim 10, wherein the ceramic in the CIELAB color space has a component a* of between −5 and 15 and a component b* of between 65 and 110.

14. The article according to claim 1, wherein the ceramic has a hardness that is greater than or equal to 1000 HV10.

15. The article according to claim 1, wherein the ceramic has a toughness K_{iC} of between 1.7 and 6 MPa √m.

16. The article according to claim 1, wherein the article consists of a component of a horological casing or movement or a component of jewellery.

17. A method of manufacturing an article according to claim 1, comprising the following steps:
producing a base, first mixture with the oxides and the doped or co-doped component of the aluminium garnet family,
forming a second mixture comprising the first mixture and an organic binder system,
granulating said second mixture,
forming a blank having the shape of the article,
sintering the blank in air at a holding temperature of between 1500 and 1800° C. for a period of between 20 minutes and 20 hours.

18. The manufacturing method according to claim 17, further comprising after the sintering step a hot isostatic pressing step at a temperature which is 50° C. to 150° C. lower than the sintering temperature.
